(19) United States
(12) Patent Application Publication
(10) Pub. No.: US 2012/0082862 A1
(43) Pub. Date: Apr. 5, 2012

(54) Elements of a Sustainable Roofing Material

(76) Inventors: Brian Stewart Weiss, Playa Del Rey, CA (US); Jeffery Alan Barrett, SR., Eagle Creek, OR (US)

(21) Appl. No.: 13/171,125

(22) Filed: Jun. 28, 2011

Related U.S. Application Data
(60) Provisional application No. 61/361,349, filed on Jul. 2, 2010.

(51) Int. Cl. B32B 27/32; B32B 9/04; B32B 27/08

(52) U.S. Cl. 428/517; 264/171.13

(57) ABSTRACT

A novel composition of materials that can be extruded into sheets to form panels to create a sustainable roofing system wherein the panels are formed to interlock with like panels in order to provide a substantially weatherproof covering on a roof. The sheet member has a top layer made of NHFR TPO (Non Halogenated Flame Resistant Thermoplastic Polyolefin) or TPP (thermo-polypropylene) and a bottom layer made of TPO (Thermoplastic Polyolefin)or TPP (thermo-polypropylene). The two layers are co-extruded. Then the materials are thermoformed to resemble more popular types of roof coverings such as shake or shingles or tiles.

### CROSS REFERENCE TO RELATED APPLICATION

This application claims the benefit of U.S. Provisional Application No. 61/361,349, filed Jul. 2, 2010, entitled ELEMENTS OF A SUSTAINABLE ROOFING MATERIAL, which application is incorporated herein in its entirety.

### BACKGROUND

Many types of roofing materials are available, and some of the more popular types include shake or shingles and tiles. Tiles are quite durable; however, their disadvantage is in that they require a substantial amount of labor in their installation and can break on impact. Tiles tend to be excessively heavy and dangerous in earthquakes and high winds, and will fall through in the event of a fire. Because they are so heavy, tiles are also expensive to ship. Wood shakes or shingles are subject to breakage, rot and loss of coloration. Their cost is high and they are labor intensive to install. Furthermore, wood shakes or shingles can be relatively heavy, are flammable, porous, and cannot withstand relatively high wind velocity.

The inherent disadvantages of tiles and shakes have led to the development of alternative roofing materials such as plastic. Several different types of plastics are known in the art. However, many of the plastics have disadvantages, which typically may include poor insulating ability, poor ability to withstand the ultra violet (UV) rays from the sun, and poor ability to withstand shock from an impact (such as from people walking on the roof or hail). Plastics tend also to be brittle and breakage with age.

Several prior art patents in the field of alternative roofing system include U.S. Pat. No. 6,536,177 issued to Frank Lane Italiane, et. al. entitled Composition of a weatherproof roofing material, U.S. Pat. No. 5,525,413 issued to Daurer, et. al. entitled Industrial roofing fabric, U.S. Pat. No. 4,507,347 issued to Lupton, et. al. entitled Laminate and U.S. Pat. No. 4,307,552 issued to Votte entitled Synthetic roofing elements of the slate type and method of manufacturing same. However, none of the prior art teaches material having the features and structural composition as will be taught in the present invention.

The composition of the roofing material is highly important in order to maximize protection from the elements and chemical pollution. Chemical pollution results from chemicals contained in smog and other air pollution. These chemicals contribute to color loss, brittleness and other factors that decrease the durability of many types of roofing material.

Thus, it is a primary objective of the present invention to provide a composition of a roofing material that provides ultraviolet protection, flame and fire retardancy, insulation, weatherability, longevity and durability. Another objective of the present invention is to provide a composition of a roofing material that is lightweight and relatively inexpensive and provides maximum protection from the weather and chemical pollution.

### SUMMARY

The present invention is a novel composition of materials that can be extruded into sheets to form panels to create a roofing system wherein the panels are formed to interlock with like panels in order to provide a substantially weatherproof covering on a roof. The roofing panel has a sheet member made of a novel composition of matter. The sheet member has a top layer made of formulated NHFR TPO (Non Halogenated Flame Resistant Thermoplastic polyolefin) or TPP (thermo-polypropylene) with a proprietary formulation of colorants, UV stabilizers and Flame resistant ingredients and a bottom layer made of formulated TPO (Thermoplastic polyolefin)or TPP (thermo-polypropylene) with flame resistant ingredients. The two layers are co-extruded. Then the extruded materials are thermoformed to resemble more popular types of roof coverings such as shakes, shingles or tiles.

The present invention uses a specialized Rigid TPO or TPP proprietary formulation that is needed to meet roofing material performance such as impact and fire resistance.

The TPO/TPP used in the invention has been researched and tested to meet the requirements of the invention. Specifically, this TPO/TPP has special characteristics that include tensile strength, elongation at break, modulus of elasticity in tension, impact strength, vicat softening temperature and density and is an impact modified, weatherable, polyolefin with high thermal stability, good chemical resistance, resistance to weathering, aging, and yellowing.

This TPO has high resistance to weathering because the elastomer component consists of an UV Stablizer having a significantly higher resistance to UV radiation and attack by atmospheric oxygen then the butadiene rubber which is used, ro example, in impact-modified polystyrene and ABS.

### DETAILED DESCRIPTION

The panel comprises a sheet member having a top layer and a bottom layer. The top layer is made of formulated NHFR TPO (Non Halogenated Flame Resistant Thermoplastic polyolefin) or TPP (thermo-polypropylene) with and the bottom layer is made of formulated TPO (Thermoplastic polyolefin) or TPP (thermo-polypropylene). The two layers are co-extruded.

The sheet member has a top surface exposed to the elements and a bottom surface that faces the surface of the roof when the panel is placed on the roof.

The bottom layer is made of a proprietary formula of TPO/TPP. The present invention uses a proprietary formulation of TPO that is needed to meet roofing material performance such as impact and fire resistance.

Further, the TPO/TPP used in this invention as described herein has specific additives that other TPO materials may not have. These additives are for resistance to UV, weathering, heat aging, high mechanical strength, impact and corrosion.

TPO/TPP has hundreds of formulations with the common characteristic being the TPO/TPP resin base. Depending upon application, many other chemicals are added to the TPO/TPP resin base. Thus, resin is referred herein as a raw, unfinished material. In the present invention resin creates the base ingredient and other unique ingredients are added to form a novel compound. These other ingredients, generally called additives, assist in the molding of the invention, adding important properties to the finished product. These additives include impact modifiers, lubricants, heat stabilizers, pigments, flame retardant, plasticizers, and processing aids. The present invention uses a proprietary formulation of TPO/TPP that is needed to meet roofing material performance such as impact and fire resistance. The TPO/TPP is specially formulated with flame retardant to provide a substantially flame retardant and flame extinguishing material for the top layer of TPO/TPP.

This present invention has created a unique polymer chain to create a TPO/TPP with certain desirable properties to have resistance to heat, toughness, and flexibility.

The present invention uses plasticizers and heat stabilizers to prevent degradation caused by the heat of processing. Pigments are added to the present invention so that the finished product will be colored throughout, flame retardant to provide a substantially flame retardant.

Flame extinguishing material is added to the TPO resin base. Processing aids and lubricants are used to assist in production and to improve the flow of resin in processing will also be included.

The unique and specific formula of the TPO/TPP was compounded to be flame retardant. Most important is the ability of the present invention's novel compound of said TPO/TPP to meet the building codes such as Underwriters Laboratories Inc. or ICBO Evaluation Service, Inc. The specific compound of the TPO/TPP compound is listed below with its specific chemical brand:

| | |
|---|---|
| 1. TPO Resin-Primex Plastics. | |
| Primex Plastics. | PH: 800-421-2936 |
| 752 Turtleback road | FX: 702-346-7150 |
| Mesquite, NV 89027 | http://primexplastics.com |
| 2. Heat Stabilizer | |
| Witco Corp. | PH: 800-494-8287 |
| One America Ln. | FX: 203-552-2850 |
| Greenwich, CT 06831 | http://www.witco.com |
| 3. Impact modifier | |
| Rohm and Haas Co. | PH: 800-356-2402 |
| 100 Independence Mall W. | FX: 215-592-2321 |
| Philadelphia, PA 19106 | http://www.rohmhaas.com |
| 4. Processing aide-K12OMD | Same as above |
| 5. Processing aide-1 < 175 | Same as above |
| 6. Lubricant-AC 316A | |
| Allied Signal Inc. | PH: 800-322-2766 |
| 101 Colombia Rd. | FX: 973-455-5000 |
| Morristown, NJ 07962 | http://www.alliedsignal.com |
| 7. Lubricant-WAX E | |
| Clariant Corp. | PH: 800-334-2823 |
| 4000 Monroe Rd. | FX: 704-377-1064 |
| Charlotte, NC 28205 | http://www.clariant.com |
| 8. Pigments-R 101 (T102) | |
| Dupont Co. | PH: 800-441-9485 |
| Titanium Dioxide | |
| P.O. Box 80036 | FX: 302-992-5273 |
| Wilmington, DE 19880 | http://www.dupont.com |
| 9. Flame Retardant-Envirostrand | |
| Anzon Inc. | PH: 800-523-0882 |
| 2545 Aramingo Ave | FX: 215-427-6955 |
| Philadelphia, PA 19125 | http://www.anzon.com |
| 10. Flame Retardant-Flame Tards | |
| Alcan Chemicals | PH: 800-321-3864 |
| 3690 Orange Place, Ste. 400 | FX: 215-765-2550 |

The sheet member is formed into panels that have a raised central portion and substantially flat lips extending from the edges. Thus, when the panel is placed on the roof, the edges and lips lay substantially flat on the roof to define a chamber between the panel and the roof. The raised central portion does not contact the roof and is formed and designed to simulate the appearance of at least one predetermined type of roofing material including but not limited to tile, slate, and wood shake or shingle.

When placed on a roof, the chamber defined by the panel and the roof traps a pocket of air that along with the TPO bottom layer provides good insulation. Also, when placed on a roof, the bottom layer faces the roof, and the top layer is exposed to the weather. The composition of the top layer and bottom layer and the unique combination of the two layers offer optimal benefits. The top layer, being made of formulated TPO, has been found to be highly resistant and durable against water as well as the wearing effects of the UV rays of the sun. And the bottom layer, being made of a specialized TPO/TPP compound, offers good insulation and has been found to be highly resistant to shock and fire. The bottom layer is also protected from the UV rays by the top layer.

### Example

A roofing panel was fabricated in accordance with the above description. The layer of TPO/TPP was 82 mil thick and before thermoforming. Based on the current design of the panel it is estimated that the desirable thickness of the product to be 0.075″ thick.

Size: Panels of approx. 1′×4′ single row or double row of 2′×4′ with an interlocking system. It is the panel design, installation, and the weight factor that significantly cuts down labor costs.

Weight: 104 pounds approximately per square (100 square feet). This product is the among the lightest weight roofing material on the market because of the novelty of the invention.

The panel was tested the following results were obtained.

| Test Description | Test Method | Result |
|---|---|---|
| 2000 hours | ASTM 5-23 | Passed. No |
| Weatherometer Test | | cracking, crazing, |
| | | flaking or any |
| | | other visible |
| | | effect on material. |
| Burn Rate | ASTM D-635 and UBC | As received 1.2 |
| | Code Standard No. | inch/mm. |
| | 26-7 | |
| | | After 2000 hours |
| | | accelerated |
| | | weathering 0.82 |
| | | inch/mm. |
| Self Ignition | ASTM D-1929, | As received 733° F. |
| | Method A and UBC | |
| | Code Standard No. | |
| | 26-6 | |
| | | After weathering |
| | | 780° F. |
| Tensile Properties | | As received |
| | | Tensile Strength |
| | | 6614 psi |
| | | Percent Elongation |
| | | 15 |
| | | After 2000 hours |
| | | carbon arc exposure |
| | | in Weatherometer |
| | | Tensile Strength |
| | | 7109 psi Percent |
| | | Elongation |
| | | 14 |
| Temperature Cycling | AC 07 | passed requirement |
| | | at 9 cycles |
| Class A Flame | UL 790 | Pass |
| Spread | | |

While a preferred embodiment of the invention has been described and illustrated for purposes of clarity and example, it should be understood that many changes, substitutions and modifications to the described embodiment will be apparent to those having skill in the art in light of the foregoing disclosure without, departing from the scope and spirit of the present invention which is defined by the claim which will follow.

As can be seen from the foregoing detailed description, aspects have been described related to roofing. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A roofing material comprising:
a top layer made of NHFR TPO (Non Halogenated Flame Resistant Thermoplastic Polyolefin) or TPP (thermo-polypropylene) material, and
a bottom layer made of TPO (Thermoplastic Polyolefin material) or TPP (thermo-polypropylene),
said top and bottom layers co-extruded together.

2. A roofing material as claimed in claim 1 in which said TPO/TPP material includes additives which impart stability against UV light, thermal aging resistance, resistance to impact, weathering and dimensional stability.

3. A roofing material as claimed in claim 1 in which said material is formulated Thermoplastic Polyolefin/Thermo-polypropylene with a flame retardant to impart substantial flame retardancy and substantial flame extinguishment properties for said top layer.

4. A method of fabricating a roofing material comprising the steps of:
obtaining TPO/TPP material formulated for use in roofing materials; and
co-extruding said TPO material into a sheet having a layer of said formulated NHFR TPO and a layer of said TPO/TPP.

5. A method of fabricating a roofing material comprising:
obtaining NHFR, TPO/TPP material formulated for use in roofing materials;
obtaining TPO/TPP material formulated for used in roofing materials;
fabricating said NHFR TPO/TPP material into sheet form.
